(19) United States
(12) Patent Application Publication
(10) Pub. No.: US 2015/0064669 A1
(43) Pub. Date: Mar. 5, 2015

(54) SYSTEM AND METHOD FOR TREATMENT OF EMOTIONAL AND BEHAVIORAL DISORDERS

(71) Applicants: Ora GOLAN, Kibbutz Nahsholim (IL); Ron GILBOA, Kibbutz Nahsholim (IL)

(72) Inventors: Ora GOLAN, Kibbutz Nahsholim (IL); Ron GILBOA, Kibbutz Nahsholim (IL)

(21) Appl. No.: 14/016,239

(22) Filed: Sep. 3, 2013

(51) Int. Cl. G09B 19/00

(52) U.S. Cl. CPC G09B 19/00
USPC 434/236

(57) ABSTRACT

A method for treating emotional and behavioural disorder includes using a sensor to obtain data pertaining to physiological responses of a user to an emotionally loaded sentence, to listed emotions, to listed chronological periods in the user's life, and to listed causes that may have led to absorption of an emotion during a period in the user's life. From the physiological response, an emotion having greatest emotional effect on the user, when it was absorbed, and its cause are determined. The user is presented with information associating the emotion, chronological period and cause. A sensor is used to obtain physiological data pertaining to the response of the user to a second instance of exposure to the emotionally loaded sentence. A result of treatment is determined by analysing and comparing the physiological data pertaining to the first and second exposures of the user to the emotionally loaded sentence.

### FIELD OF THE INVENTION

The present invention relates to systems and methods for treating emotional and behavioral disorders.

### BACKGROUND OF THE INVENTION

Emotional and behavioral disorders affect most people at some time in their lives. For some, emotional and behavioral disorders (hereinafter referred to as—EBD) pose a substantial obstacle in their daily lives, resulting in a substantial reduction in the quality of life.

EBD include, inter-alia, anxiety disorders, bipolar disorders, conduct disorders, eating disorders, obsessive-compulsive disorders (OCD) and psychiatric disorders and phobias of various kinds.

EBD affect many by inflicting anxiety, stress, insecurity, tension, degraded self-image, marital and relationship problems, damaged social status, personal, social, professional, familial, relationship and schooling problems, etc.

As a result people who are affected by EBD are unable to fully exploit their skills and potentials in various aspects of their lives.

There are known systems and methods for diagnosing EBD. For example, there are automated systems that are capable of diagnosing EBD based on questionnaires that are answered by a subject suspected of having EBD. Other automated systems employ various imaging techniques, using, for example, image acquiring sensors, such as a cepstral, audio sensors, such as a microphone, to detect visual and audio signs which may be interpreted as symptoms of EBD, using various detection and interpretation techniques (e.g., behavioral detection, anxiety detection, stress detection, tension detection, lie-detection, etc.)

There are also systems and methods for treating subjects having EBD. Typically, such systems offer a treatment which is based on psychological or cognitive elements, replacing, in effect, a human therapist.

### SUMMARY OF THE INVENTION

There is thus provided, in accordance with some embodiments of the present invention, a method of EBD treatment. The method may include using a sensor to obtain physiological data pertaining to a physiological response of the user to an emotionally loaded sentence the user is exposed to at a first instance.

The method may also include using the sensor to obtain physiological data pertaining to the physiological response of the user to each emotion of the list of emotions.

The method may further include determining which emotion from the list of emotions has a greatest emotional effect on the user, based on analyzing the physiological data pertaining to the physiological response of the user to each emotion of the list of emotions.

Further, the method may include using the sensor to obtain physiological data pertaining to the physiological response of the user to each chronological period of a list of chronological periods in the user's life.

The method may also include using the sensor to obtain physiological data pertaining to the physiological response of the user to each chronological period of a list of chronological periods in the user's life.

The method may further include determining a chronological period of the list of chronological periods of the user's life during which the determined emotion was absorbed, based on analyzing the physiological data pertaining to the physiological response of the user to that chronological period.

The method may also include using the sensor to obtain physiological data pertaining to the physiological response of the user to each cause of a list of causes that may have led to the absorption of determined emotion during the determined chronological period in the user's life.

The method may further include determining a cause from the list of causes that has caused the determined emotion to be absorbed during the determined chronological period in the user's life, based on analyzing the physiological data pertaining to the physiological response of the user to that cause.

The method may also include presenting to the user with information associating the determined emotion, the determined chronological period and the determined cause.

The method may still further include using the sensor to obtain physiological data pertaining to the physiological response of the user to the emotionally loaded sentence the user is exposed to at a second instance, and determining a result of the treatment based on analyzing and comparing the physiological data pertaining to the physiological response of the user to the emotionally loaded sentence the user was exposed to at the first instance with the physiological data pertaining to the physiological response of the user to the emotionally loaded sentence the user was exposed to at the second instance.

In some embodiments of the present invention, the method may be performed iteratively.

In some embodiments, the method may include presenting the user with instructions to say out loud the sentences.

According to some embodiments, the physiological data may be selected form the group of physiological data consisting of: voice, muscle strength, blood pressure, heart rate, facial expressions, eye movement, sweating, skin conductivity, body language, body temperature, brain waves, hormone level, sugar level.

In some embodiments, the physiological data is voice and analyzing comprises extracting voice parameters selected from the group of parameters consisting of sound volume (measured in decibels), pitch, straight, snack, formant frequencies, harmonic amplitudes, corrected relative harmonic amplitudes, corrected relative formant frequencies, RMS energy, cepstral peak prominence, harmonic to noise ratio, and silent intervals between adjacent phonemes.

According to some embodiments, the sensor is selected from the group of sensors consisting of: microphone, camera, heartbeat monitor, blood-pressure measuring device, skin conductivity measuring device, brain waves detector, and infrared camera.

A non-transitory computer readable medium having stored thereon instructions for treating EBD and a system for treating EBD are also provided.

### BRIEF DESCRIPTION OF THE DRAWINGS

In order to better illustrate examples, the following figures are provided and referenced hereafter. It should be noted that the figures are given as examples only and in no way limit the scope of the present disclosure. It will be appreciated that for simplicity and clarity of illustration, elements shown in the figures have not necessarily been drawn to scale. For example, the dimensions of some of the elements may be exaggerated relative to other elements for clarity. Like components are denoted by like reference numerals.

FIG. 1 illustrates a method of EBD treatment, according to some embodiments of the present invention.

FIG. 2 illustrates a system for treating EBD, operated on a single computing device, according to some embodiments of the present invention.

FIG. 3 illustrates a process for treating EBD, according to some embodiments of the present invention.

FIG. 4 illustrates a system for treating EBD, operated over a network, according to some embodiments of the present invention.

FIG. 5 illustrates a computing device, suitable for a system for treating EBD, according to some embodiments of the present invention.

### DETAILED DESCRIPTION OF THE INVENTION

In the following detailed description, numerous specific details are set forth in order to provide a thorough understanding of the methods and systems. However, it will be understood by those skilled in the art that the present methods and systems may be practiced without these specific details. In other instances, well-known methods, procedures, and components have not been described in detail so as not to obscure the present methods and systems.

Although the examples disclosed and discussed herein are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. Unless explicitly stated, the method examples described herein are not constrained to a particular order or sequence. Additionally, some of the described method examples or elements thereof can occur or be performed at the same point in time.

Unless specifically stated otherwise, as apparent from the following discussions, it is appreciated that throughout the specification, discussions utilizing terms such as “adding”, “associating” “selecting,” “evaluating,” “processing,” “computing,” “calculating,” “determining,” “designating,” “allocating” or the like, refer to the actions and/or processes of a computer, computer processor or computing system, or similar electronic computing device, that manipulate, execute and/or transform data represented as physical, such as electronic, quantities within the computing system's registers and/or memories into other data similarly represented as physical quantities within the computing system's memories, registers or other such information storage, transmission or display devices.

The present invention seeks to provide systems and methods for treating humans having EBD problems Systems and methods for treating EBD, according to some embodiments of the present invention, involve treatment which does not require the subject to acquire new skills, nor requires the subject to be engaged in confrontation or learn new behaviour.

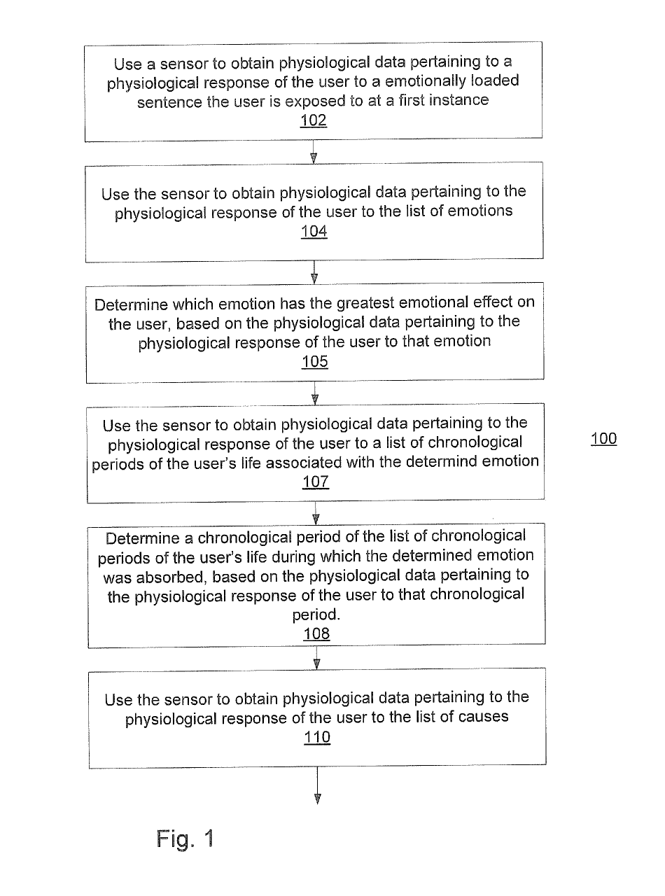

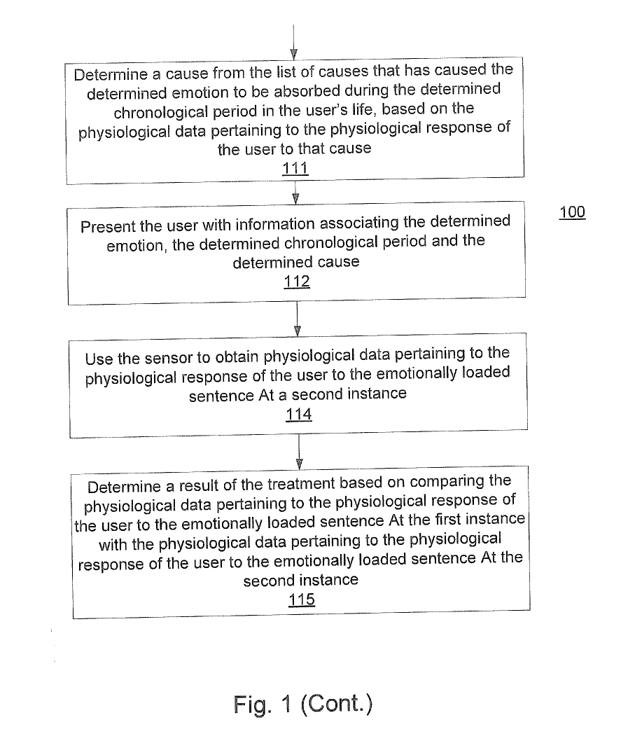

A method of EBD treatment, according to some embodiments of the present invention, is illustrated in FIG. 1. Method 100 includes using a sensor to obtain 102 physiological data pertaining to a physiological response of the user to an emotionally loaded sentence the user is exposed to at a first instance.

Method 100 still further includes using the sensor to obtain 104 physiological data pertaining to the physiological response of the user to each emotion of the list of emotions.

Method 100 also includes determining 105 which emotion from the list of emotions has the greatest emotional effect on the user, based on the physiological data pertaining to the physiological response of the user to each emotion of the list of emotions.

Method 100 also includes using 107 the sensor to obtain physiological data pertaining to the physiological response of the user to the list of chronological periods of the user's life associated with the determined emotion.

Method 100 also includes determining 108 a chronological period of the list of chronological periods of the user's life during which the determined emotion was absorbed, based on the physiological data pertaining to the physiological response of the user to that chronological period.

Method 100 still further includes using the sensor to obtain 110 physiological data pertaining to the physiological response of the user to each cause in a list of causes. Method 100 further includes (FIG. 1 continues to the next sheet) determining 111a cause from the list of causes that has the greatest influence in causing the determined emotion to be absorbed during the determined chronological period in the user's life, based on the physiological data pertaining to the physiological response of the user to that cause. Method 100 still further includes presenting 112 the user with information associating the determined emotion, the determined chronological period and the determined cause.

Method 100 also includes using the sensor to obtain 114 physiological data pertaining to the physiological response of the user to the emotionally loaded sentence at a second instance. The second instance may be after completing the previous method steps.

Method 100 further includes determining 115 a result of the treatment based on comparing the physiological data pertaining to the physiological response of the user to the emotionally loaded sentence at the first instance with the physiological data pertaining to the physiological response of the user to the emotionally loaded sentence at the second instance.

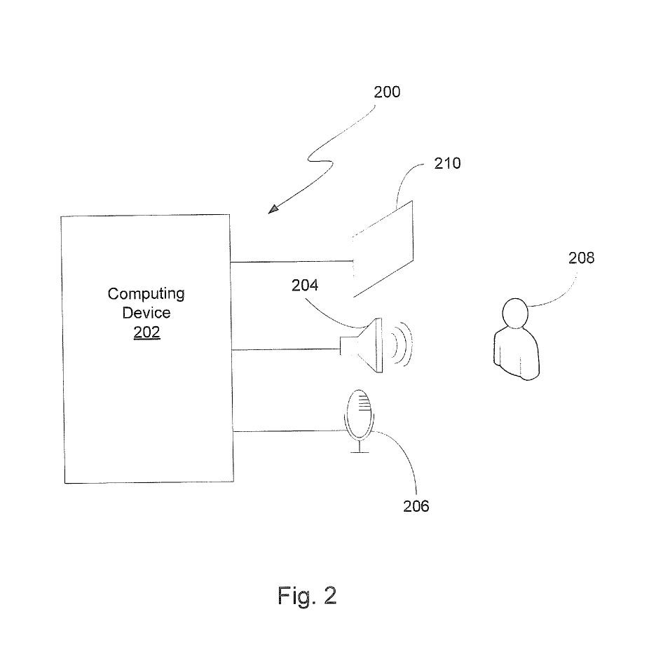

FIG. 2 illustrates a system 200 for treating EBD, operated on a single computing device, according to some embodiments of the present invention.

System 200 includes a computing device 202, which may be any computing platform, such as personal computer (PC), mobile computing device (e.g., laptop), hand-held device (e.g., personal digital assistant, FDA), mobile communication device, smartphone, etc.

In some embodiments of the present invention, the computing device 102 is configured to execute a software application (hereinafter—application). The application may be physically installed locally on the computing device (e.g., stored on a storing device which is a part of the computing device), or may be installed in a remote server, which is accessible to the computing device 202.

For sake of brevity, the following description will now refer to a locally installed application, without limiting the scope of the present invention to other configurations.

In some embodiments of the present invention, a user interface is provided, which is designed to facilitate communication between a user 208 and the computing device. The user interface may include video and/or audio, such as, for example, a graphical user interface and may include graphical information (e.g., text, drawings, symbols) which are presented on a screen 210. Screen 210 may be a separate screen or a built-in screen, which is a part of the computing device 202. The graphical information may include instructions and information for the user.

Alternatively, or in addition, loudspeaker 204 is provided, which may be a single loudspeaker, or a plurality of speakers (e.g., an array of 2 or more speakers), e.g., a mono loudspeaker, stereo loudspeakers, surround speaker system, a headphone or headphones, an earphone or earphones, etc. Loudspeaker 204 may be used to provide audio instructions and information to the user.

A sensor for obtaining physiological data pertaining to a physiological response of the user is provided. The obtained physiological data may relate, for example, to changes in voice pitch harmony and volume, muscle strength, blood pressure, heart rate, facial expressions, eye movement, sweating, skin conductivity, body language, body temperature, brain waves, hormone level changes, sugar level changes etc., Such a device may be, for example, microphone, camera, heartbeat monitor, blood-pressure measuring device, etc.

In the system depicted in FIG. 2, microphone 206 for acquiring the voice of a user is provided, which may separate from the computing device 202 or a built-in microphone of the computing device 202.

The microphone is selected such that its characteristics are suitable for picking up human voice (typically within the frequency range of 300-3400 Hz). Microphone 106 is used to acquire speech generated by the user.

In the context of the present specification, “presenting” or “instructing” the user with information or instructions, refers to presenting audio information or instructions via loudspeaker 204, or presenting video information or instructions via screen 210, or a combination thereof.

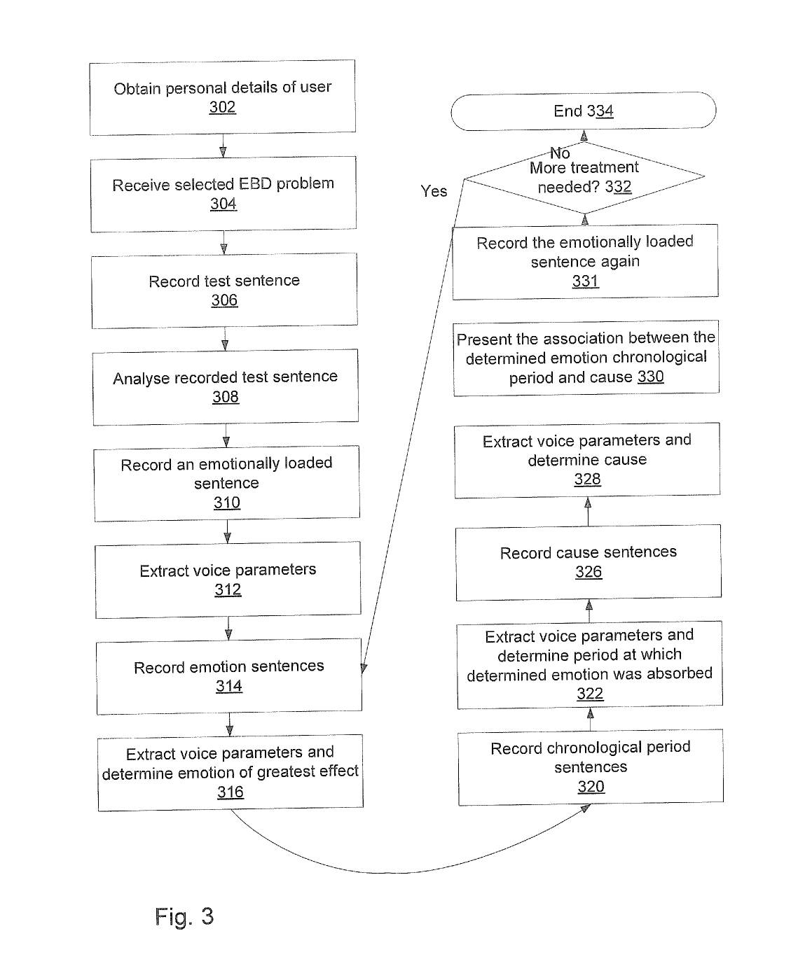

According to some embodiments of the present invention, the computing device is configured to perform the following process 300 for treating EBD, as illustrated in FIG. 3.

At first the user may be presented with inquiries designed to obtain 302 personal details (e.g., name, sex, age). This may be carried out, for example, by presenting graphical information on screen 210 (see FIG. 2), providing an audio request for this information, e.g., through loudspeaker 204 (see FIG. 2), or both. The user may be presented with a form in which such information is to be entered, e.g., via an input interface, which may include, for example, keyboard, pointing device, touch screen (e.g., screen 210 may be a touch screen), etc, or be asked to provide this information verbally, so it may be picked up by microphone 206, and interpreted using a voice interpretation technique.

The user may then be required to select the specific EBD problem for treatment from a list of problems that is presented to the user, e.g., by using the input interface, or by naming the problem so that it is picked up by microphone 106. The computing device thus receives 304 the selected problem.

The user may then be presented with an instruction to read or repeat out loud a sentence that is presented to the user, or say a few words (e.g. a free sentence). The system would record 306 the test sentence via microphone 206 (FIG. 2), for testing receipt level (e.g., recording level) of the microphone 106, to make sure that the audio reception of system 200 is in order, and that the sound quality of the recording is adequate.

Noise filtering techniques may be used, e.g., employed by computing device 202. Such filtering techniques may include low pass filtering, noise reduction, smoothing etc.

The computing device 202 then analyzes 308 the recorded test sentence to confirm that it is suitable (e.g., the recorded signal is above a predetermined threshold). If the recorded test sentence is not confirmed the user may be presented with an instruction to repeat the step of recording the test sentence, until the computing device 202 determines that the recorded test sentence is suitable.

Computing device 202 would then present the user with an instruction to record an emotionally loaded sentence relating to the EBD problem of the user (e.g., “it is OK for me to fail”). In some embodiments of the present invention, the user may also be instructed to say a neutral sentence (e.g., “it is OK that the colour of the moon is white”), which does not relate to the EBD problem.

The emotionally loaded sentence (and the neutral sentence is it was recorded too) is recorded 310 and processed by the computing device to extract 312 voice parameters and establish a primary base-line reference. The extracted voice parameters may be selected from: sound volume (measured in decibels), pitch, straight, snack, formant frequencies, harmonic amplitudes, corrected relative harmonic amplitudes, corrected relative formant frequencies, RMS energy, cepstral peak prominence, harmonic to noise ratio, silent intervals between adjacent phonemes, etc. The extracted parameters may be averaged and a standard deviation may be calculated. Thus, a base-line reference may be established.

Next, the user is presented with an instruction to record 314 additional sentences relating to different types of emotions (e.g., fear, threat, anger, resentment, low self-esteem, lack of control) to determine which of these emotions has the greatest emotional effect on the user. These recorded sentences are analyzed by extracting 316 voice parameters and determining the user's emotion, based on the extracted voice parameters. According to some embodiments of the present invention, the emotion whose corresponding extracted parameters that showed the greatest deviation from the base-line reference is determined to be the emotion that has the greatest effect on the user.

Next, the user is presented with an instruction to record 320 additional sentences associating the determined emotion with different chronological periods in the user's life. (e.g., fetal period, infancy, childhood, adulthood) to determine at what chronological period in the user's life the determined emotion was absorbed. The user may be instructed to say sentences bearing the general form of: “I got” (determined emotion) “during” (chronological period). For example, if the determined emotion was fear, the user would be instructed to say the following sentences: “I got fear during my fetal period”, “I got fear during my infancy”, “I got fear during my childhood” and “I got fear during my adulthood”.

Voice parameters are extracted 322 from the recorded chronological period sentences to determine the chronological period at which the determined emotion was absorbed.

Next, the user is presented with an instruction to record 326 additional sentences associating the determined emotion and the determined chronological period with a cause or causes.

The user may be instructed to say sentences bearing the general form of: “The” (determined emotion) “during my” (chronological period) “was absorbed” (cause). For example, if the determined emotion was fear, and the determined chronological period was childhood, the user would be instructed to say the following sentences: “The fear during my childhood was absorbed from people around me”, or “The fear during my childhood was absorbed because I did not get my emotional needs”.

These cause sentences are analyzed by extracting 328 voice parameters to determine the cause or causes which had the greatest influence on the user in absorbing the determined emotion during the determined chronological period in the user's life.

Thus, the user is diagnosed to determine what emotion most affects him/her, when it was absorbed and what was the cause of the absorption of that emotion.

The user is then caused to relate to the diagnosis by presenting 330 the discovered association between the determined emotion, determined chronological age and the cause. In some embodiments of the present invention, the user may be presented with a message to that effect, in the form: “imagine yourself at” (determined chronological period) “feeling” (determined emotion) “that you absorbed” “from” or “because of” (cause). For example, if the determined emotion is fear, the determined chronological period is childhood and the determined cause is people around the user, the message could be “imagine yourself in your childhood, feeling fear that you absorbed from people around you, because they were experiencing fear” Presenting the user with such message may cause the user to reflect on the presented association between the determined emotion, determined chronological age and the cause. It is believed that this may have an easing effect on the user's EBD problem.

At that point, the user may be presented with an instruction to record 331 the emotionally loaded sentence again. The emotionally loaded sentence that was recorded again is then analyzed (by relating to extracted voice parameters) to determine whether the treatment is successful or satisfactory. This may be based, for example, on comparing the deviations of voice parameters of the recorded emotionally loaded sentence, and the voice parameters of the emotionally loaded sentence that was recorded again, from the base-line and determining whether the deviation of the voice parameters of the emotionally loaded sentence that was recorded again from the base-line is smaller than the voice parameters of the emotionally loaded sentence first recorded, or whether the difference in the deviations exceeds a predetermined threshold.

If the treatment is not proven successful or satisfactory, the user is instructed to perform the process again at a later time. While returning to the system, the user would start the process again by recording 314 the emotion sentences performing the process iteratively, until it is determined 332 that the treatment is successful or satisfactory, at which time the process ends 334.

The entire process described may be performed or reiterated for different emotionally loaded sentences.

The process hereinabove was described with reference to recorded speech (sentences spoken by the user) and voice analysis, yet, other embodiments of the present invention may relate to other physiological data, such as, for example, muscle strength, blood pressure, heart rate, facial expressions, eye movement, sweating, skin conductivity, body language, etc., and employ other or additional sensors, such as camera, heartbeat monitor, blood-pressure measuring device, skin conductivity measuring device, brain waves detector, infrared camera etc,

A system for treating EBD, according to some embodiments of the present invention, may be a stand-alone system operated on a single computing device (e.g., personal computer (PC), mobile computing device such as, for example, a laptop, hand-held device, for example a personal digital assistant (PDA), mobile communication device, smartphone, etc.

In some embodiments of the present invention, a system for treating EBD may be operated over a communication network.

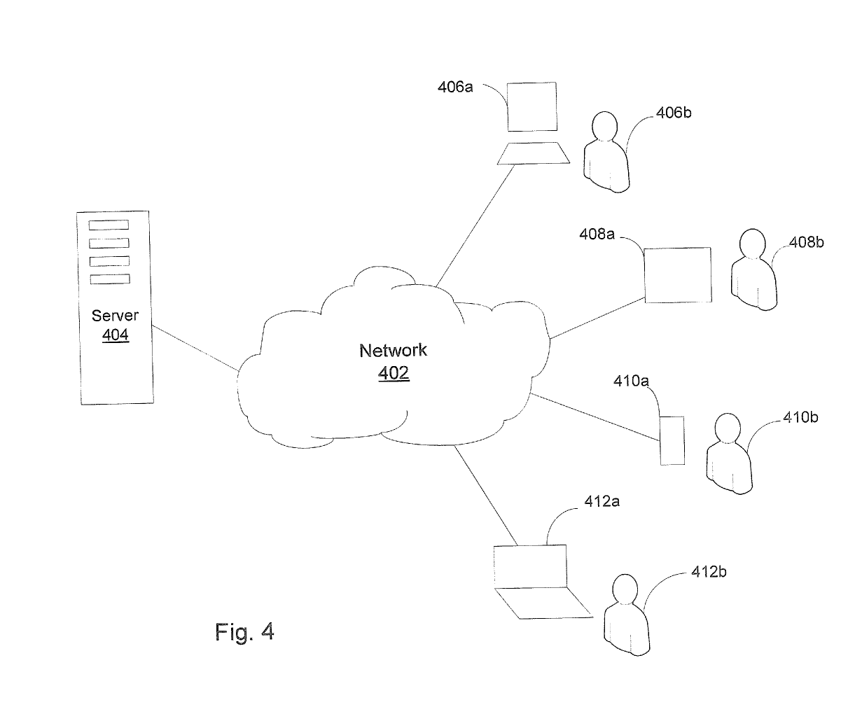

FIG. 4 illustrates a system for treating EBD, operated over a network, according to some embodiments of the present invention.

This system may be designed to treat a plurality of users—here depicted by users 406b, 408b, 410b and 412b. Each user may have a personal computing device associated with that user, e.g., user 406b is associated with PC 406a, user 408b is associated with tablet 408a, user 410b is associated with smartphone 410a and user 412b is associated with laptop 412a.

The computing device of each user may have a user application installed on that device, which may be designed to perform a portion of a method for treating EBD in accordance with some embodiments of the present invention, whereas the rest of the method may be performed on a remote computing device.

For example, the user may be presented with instructions by the personal computing device associate with that user (e.g., video instructions via a screen, or audio instructions via a loudspeaker, or a combination of both). The user may also record sentences using a microphone which is connected to or is a part of the personal computing device associated with that user.

The analysis of the recorded speech may be carried out on a remote computing device, e.g., remote server 404, which is designed to communicate with the personal computing devices of each of the users over a network 402 (e.g., the Internet). Further, the server may be configured to determine whether the method requires iterations and cause personal computing devices of the users to continue with presenting further instructions to the users and recording their speech. In some embodiments the server may keep records of various users and offer a historical perspective of user treatments.

In some embodiments of the present invention, the distribution of a method for treating EBD between the personal computing device and the remote server may vary.

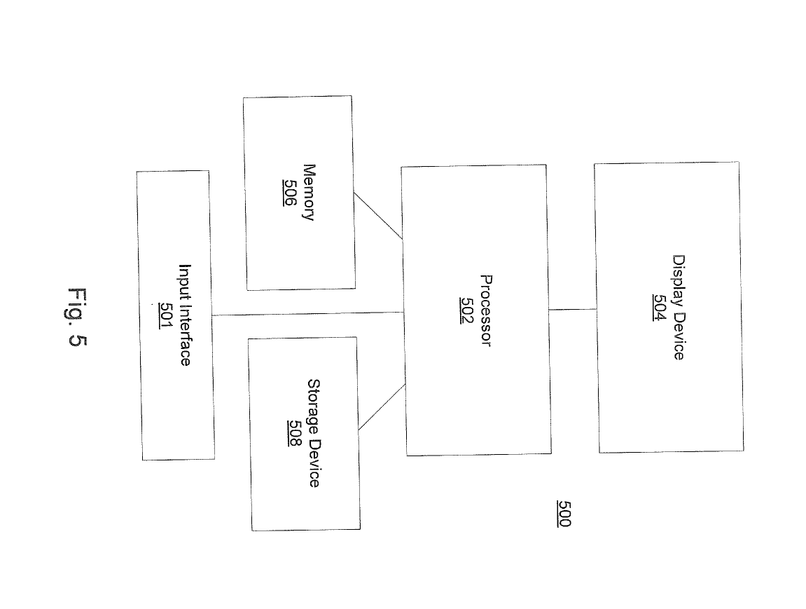

FIG. 5 illustrates a computing device (202, FIG. 2) suitable for a system for treating EBD according to some embodiments of the invention.

System 500 may include a processor 502 (e.g. one or a plurality of processors, on a single machine or distributed on a plurality of machines) for executing a method according to some embodiments. Processor 502 may be linked with memory 506 on which a program implementing a method according to examples and corresponding data may be loaded and run from, and storage device 508, which includes a non-transitory computer readable medium (or mediums) such as, for example, one or a plurality of hard disks, flash memory devices, etc. on which a program implementing a method according to examples and corresponding data may be stored. System 500 may further include display device 504 (e.g. CRT, LCD, LED touchscreen, etc.) on which one or a plurality user interfaces associated with a program implementing a method according to embodiments of the present invention and corresponding data may be presented. System 500 may also include input device 501, such as, for example, one or a plurality of keyboards, pointing devices, touch sensitive surfaces (e.g. touch sensitive screens), etc. for allowing a user to input commands and data.

Some embodiments of the present invention may be embodied in the form of a system, a method or a computer program product. Similarly, some embodiments may be implemented as hardware, software or a combination of both. Some embodiments of the present invention may be embodied as a computer program product saved on one or more non-transitory computer readable medium (or media) in the form of computer readable program code embodied thereon. Such non-transitory computer readable medium may include instructions that when executed cause a processor to execute method steps in accordance with some embodiments. In some embodiments the instructions stores on the computer readable medium may be in the form of an installed application and in the form of an installation package.

Such instructions may be, for example, loaded by one or more processors and get executed.

For example, the computer readable medium may be a non-transitory computer readable storage medium. A non-transitory computer readable storage medium may be, for example, an electronic, optical, magnetic, electromagnetic, infrared, or semiconductor system, apparatus, or device, or any combination thereof.

Computer program code may be written in any suitable programming language. The program code may execute on a single computer system, or on a plurality of computer systems.

Some embodiments of the present invention are described hereinabove with reference to flowcharts and/or block diagrams depicting methods, systems and computer program products according to various embodiments.

Features of various embodiments discussed herein may be used with other embodiments discussed herein. The foregoing description of the embodiments has been presented for the purposes of illustration and description. It is not intended to be exhaustive or limiting to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes that fall within the true spirit of the disclosure.

1. A method of EBD treatment, the method comprising:
using a sensor to obtain physiological data pertaining to a physiological response of the user to an emotionally loaded sentence the user is exposed to at a first instance;
using the sensor to obtain physiological data pertaining to the physiological response of the user to each emotion of the list of emotions;
determining which emotion from the list of emotions has a greatest emotional effect on the user, based on analyzing the physiological data pertaining to the physiological response of the user to each emotion of the list of emotions;
using the sensor to obtain physiological data pertaining to the physiological response of the user to each chronological period of a list of chronological periods in the user's life;
determining a chronological period of the list of chronological periods of the user's life during which the determined emotion was absorbed, based on analyzing the physiological data pertaining to the physiological response of the user to that chronological period;
using the sensor to obtain physiological data pertaining to the physiological response of the user to each cause of a list of causes that may have led to the absorption of determined emotion during the determined chronological period in the user's life;
determining a cause from the list of causes that has caused the determined emotion to be absorbed during the determined chronological period in the user's life, based on analyzing the physiological data pertaining to the physiological response of the user to that cause;
presenting to the user with information associating the determined emotion, the determined chronological period and the determined cause;
using the sensor to obtain physiological data pertaining to the physiological response of the user to the emotionally loaded sentence the user is exposed to at a second instance; and
determining a result of the treatment based on analyzing and comparing the physiological data pertaining to the physiological response of the user to the emotionally loaded sentence the user was exposed to at the first instance with the physiological data pertaining to the physiological response of the user to the emotionally loaded sentence the user was exposed to at the second instance.

2. The method of claim 1, performed iteratively.

3. The method of claim 1, further comprising presenting the user with instructions to say out loud the sentences.

4. The method of claim 1, wherein the physiological data is selected form the group of physiological data consisting of: voice, muscle strength, blood pressure, heart rate, facial expressions, eye movement, sweating, skin conductivity, body language, body temperature, brain waves, hormone level and sugar level.

5. The method of claim 4, wherein the physiological data is voice and analyzing comprises extracting voice parameters selected from the group of parameters consisting of sound volume (measured in decibels), pitch, straight, snack, formant frequencies, harmonic amplitudes, corrected relative harmonic amplitudes, corrected relative formant frequencies, RMS energy, Cepstral peak prominence, harmonic to noise ratio, and silent intervals between adjacent phonemes.

6. The method of claim 1, wherein the sensor is selected from the group of sensors consisting of: microphone, camera, heartbeat monitor, blood-pressure measuring device skin conductivity measuring device, brain waves detector, and infrared camera.

7. A non-transitory computer readable medium having stored thereon instructions for treating EBD, which when executed by a processor, cause the processor to
use a sensor to obtain physiological data pertaining to a physiological response of the user to an emotionally loaded sentence the user is exposed to at a first instance;
use the sensor to obtain physiological data pertaining to the physiological response of the user to each emotion of the list of emotions;
determine which emotion from the list of emotions has a greatest emotional effect on the user, based on analyzing the physiological data pertaining to the physiological response of the user to each emotion of the list of emotions;
use the sensor to obtain physiological data pertaining to the physiological response of the user to each chronological period of a list of chronological periods in the user's life;
determine a chronological period of the list of chronological periods of the user's life during which the determined emotion was absorbed, based on analyzing the physiological data pertaining to the physiological response of the user to that chronological period;
use the sensor to obtain physiological data pertaining to the physiological response of the user to each cause of a list of causes that may have led to the absorption of determined emotion during the determined chronological period in the user's life;
determine a cause from the list of causes that has caused the determined emotion to be absorbed during the determined chronological period in the user's life, based on analyzing the physiological data pertaining to the physiological response of the user to that cause;
present to the user with information associating the determined emotion, the determined chronological period and the determined cause;
use the sensor to obtain physiological data pertaining to the physiological response of the user to the emotionally loaded sentence the user is exposed to at a second instance; and
determine a result of the treatment based on analyzing and comparing the physiological data pertaining to the physiological response of the user to the emotionally loaded sentence the user was exposed to at the first instance with the physiological data pertaining to the physiological response of the user to the emotionally loaded sentence the user was exposed to at the second instance.

8. The non-transitory computer readable medium of claim 7, wherein the instructions, when executed by the processor cause the processor to perform iteratively.

9. The non-transitory computer readable medium of claim 7, wherein the instructions, when executed by the processor, cause the processor to present the user with instructions to say out loud the sentences.

10. The non-transitory computer readable medium of claim 7, wherein the physiological data is selected form the group of physiological data consisting of: voice, muscle strength, blood pressure, heart rate, facial expressions, eye movement, sweating, skin conductivity, body language, body temperature, brain waves, hormone level, and sugar level.

11. The non-transitory computer readable medium of claim 7, wherein the physiological data is voice and analyzing comprises extracting voice parameters selected from the group of parameters consisting of sound volume (measured in decibels), pitch, straight, snack, formant frequencies, harmonic amplitudes, corrected relative harmonic amplitudes, corrected relative formant frequencies, RMS energy, Cepstral peak prominence, harmonic to noise ratio, and silent intervals between adjacent phonemes.

12. The non-transitory computer readable medium of claim 11, wherein the sensor is selected from the group of sensors consisting of: microphone, camera, heartbeat monitor, blood-pressure measuring device, skin conductivity measuring device, brain waves detector, and infrared camera.

13. A system for treating EBD comprising a processor configured to:
use a sensor to obtain physiological data pertaining to a physiological response of the user to an emotionally loaded sentence the user is exposed to at a first instance;
use the sensor to obtain physiological data pertaining to the physiological response of the user to each emotion of the list of emotions;
determine which emotion from the list of emotions has a greatest emotional effect on the user, based on analyzing the physiological data pertaining to the physiological response of the user to each emotion of the list of emotions;
use the sensor to obtain physiological data pertaining to the physiological response of the user to each chronological period of a list of chronological periods in the user's life;
determine a chronological period of the list of chronological periods of the user's life during which the determined emotion was absorbed, based on analyzing the physiological data pertaining to the physiological response of the user to that chronological period;
use the sensor to obtain physiological data pertaining to the physiological response of the user to each cause of a list of causes that may have led to the absorption of determined emotion during the determined chronological period in the user's life;
determine a cause from the list of causes that has caused the determined emotion to be absorbed during the determined chronological period in the user's life, based on analyzing the physiological data pertaining to the physiological response of the user to that cause;
present to the user with information associating the determined emotion, the determined chronological period and the determined cause;
use the sensor to obtain physiological data pertaining to the physiological response of the user to the emotionally loaded sentence the user is exposed to at a second instance; and
determine a result of the treatment based on analyzing and comparing the physiological data pertaining to the physiological response of the user to the emotionally loaded sentence the user was exposed to at the first instance with the physiological data pertaining to the physiological response of the user to the emotionally loaded sentence the user was exposed to at the second instance.

14. The system of claim 13, wherein the processor is configured to perform iteratively.

15. The system of claim 13, wherein the processor is configured to cause presenting the user with instructions to say out loud the sentences.

16. The system of claim 13, wherein the physiological data is selected form the group of physiological data consisting of: voice, muscle strength, blood pressure, heart rate, facial expressions, eye movement, sweating, skin conductivity, body language, body temperature, brain waves, hormone level, and sugar level.

17. The system of claim 16, further comprising the sensor.

18. The system of claim 17, wherein the sensor is selected from the group of sensors consisting of: microphone, camera, heartbeat monitor, blood-pressure measuring device, skin conductivity measuring device, brain waves detector, and infrared camera.

19. The system of claim 13, embodied in a single computing device.

20. The system of claim 19, wherein the computing device is selected form the group of computing device that consists of a personal computer, mobile computing device, laptop, hand-held device, personal digital assistant, mobile communication device, and smartphone.
